(19) United States
(12) Patent Application Publication
(10) Pub. No.: US 2008/0135398 A1
(43) Pub. Date: Jun. 12, 2008

(54) Method For Manufacturing Carbonaceous Material

(76) Inventors: Takeshi Azami, Tokyo (JP); Sumio Iijima, Tokyo (JP); Masako Yutasaka, Tokyo (JP)

Correspondence Address: HAYES SOLOWAY P.C., 3450 E. SUNRISE DRIVE, SUITE 140, TUCSON, AZ, 85718, US

(21) Appl. No.: 11/813,505

(22) PCT Filed: Dec. 27, 2005
(86) PCT No.: PCT/JP05/23969

§ 371 Date: Oct. 4, 2007

(30) Foreign Application Priority Data
Jan. 6, 2005 (JP) 2005-001951

(51) Int. Cl. B01J 19/12; C01B 31/04

(52) U.S. Cl. 204/157.41; 423/460

(57) ABSTRACT

A method is provided for manufacturing a carbonaceous material in which fine carbon particles structured from clumps of numerous tube-shaped graphite sheets are aggregated, wherein the carbonaceous material can be readily obtained at a high yield and having a fine carbon particle-diameter distribution that is in a relatively narrow range.

The present invention comprises a carbon ablation step performed in a neon-gas atmosphere within a chamber 10; and
a cooling step for using the neon-gas atmosphere within the chamber to cool a gasified carbon (plume CP) generated in the ablation step. The carbonaceous material in which fine carbon particles are aggregated is obtained by performing the ablation step and the cooling step.

### TECHNICAL FIELD

The present invention relates to a method for manufacturing a carbonaceous material and more specifically relates to a method for manufacturing a carbonaceous material in which fine carbon particles structured from clumps of numerous tube-shaped graphite sheets are aggregated.

### BACKGROUND ART

Conventional carbonaceous materials commonly referred to as “carbon nano-materials” have gained notice as substrates (carriers) for carrying catalysts; adsorbents or structural materials for adsorbents for adsorbing chemicals, DNA (deoxyribonucleic acid), or the like; sorbent materials for hydrogen gas or methane gas; solid lubricants, friction materials, and the like. Carbon nanohorn aggregates are representative of such carbonaceous materials, and can be broadly classified into dahlia-like carbon nanohorn aggregates and bud-like carbon nanohorn aggregates, as described in, e.g., Patent Document 1.

Dahlia-like carbon nanohorn aggregates are fine particulates containing numerous groupings of fine carbon particles shaped like dahlia flowers (referred to below as “dahlia-like fine carbon particles”) from which protrude numerous horn-shaped single-walled carbon nanotubes whose tips are closed by five-membered rings. The various dahlia-like fine carbon particles have an average maximum diameter of about 100 nm, and the angle of the tip of the horn-shaped single-walled nanotubes is about 20° when viewed from the surface. On the other hand, bud-like carbon nanohorn aggregates are fine particulates having numerous groupings of fine spherical carbon particles (referred to below as “bud-like fine carbon particles”) that are thought to contain numerous carbon nanotubes, but the structure of the carbon nanotubes in the individual bud-like fine carbon particles is non-uniform. Horn-shaped protrusions are also not substantially seen on the surface of individual bud-like fine carbon particles. The average maximum diameter of bud-like fine carbon particles depends on structural conditions but is about 100 nm. The specific surface area of these carbon nanohorn aggregates is large at about 280 to 300 cm² in both cases.

Such carbon nanohorn aggregates are obtained as sooty materials generated when solid elemental carbon is vaporized in an atmosphere of argon (Ar) gas, helium (He) gas, nitrogen (N₂) gas, or another inert gas, as described in, e.g., Patent Documents 1 through 3. The yield is about 90% for dahlia-like carbon nanohorn aggregates and about 80% or less for bud-like carbon nanohorn aggregates.

[Patent Document 1] Japanese Laid-Open Patent Application No. 2003-20215 (see paragraphs 0002 through 0006, 0016 through 23, and 0027 through 0030)

[Patent Document 2] Japanese Laid-Open Patent Application No. 2003-25297 (see paragraph 0021)

[Patent Document 3] Japanese Laid-Open Patent Application No. 2003-95624 (see paragraphs 0014 through 0015 and 0021)

### DISCLOSURE OF THE INVENTION

### Problems the Invention is Intended to Solve

However, the particle-diameter distribution of the fine carbon particles in one lot of carbon nanohorn aggregates obtained by conventional methods spans a relatively wide range. The particle-diameter distribution of dahlia-like fine carbon particles in dahlia-like carbon nanohorn aggregates spans, e.g., about 45 to 220 nm, and the particle-diameter distribution of bud-like fine carbon particles in bud-like carbon nanohorn aggregates spans, e.g., about 50 to 130 nm. The range of the particle-diameter distribution of the fine carbon particles in carbon nano-materials is needed to be as narrow as possible from the standpoint of obtaining a constant quality for products in which carbon nano-materials are used. The yield of carbon nano-materials is also needed to be as high as possible.

With the foregoing problems in view, it is an object of the present invention to provide a method for manufacturing a carbonaceous material in which fine carbon particles structured from clumps of numerous tube-shaped graphite sheets are aggregated, wherein the particle-diameter distribution of the fine carbon particles can be limited to a narrower range than in conventional methods, and the carbonaceous material can be obtained at a high yield.

### Means for Solving the Aforementioned Problems

The method for manufacturing a carbonaceous material according to the present invention is characterized in comprising a carbon ablation step performed in a neon-gas atmosphere within a chamber; and a cooling step for using the neon-gas atmosphere within the chamber to cool a gasified carbon generated in the ablation step, wherein a carbonaceous material in which a plurality of fine carbon particles is aggregated is thereby obtained. “Fine carbon particles” in this instance refers to carbon particles structured from clumps of numerous tube-shaped graphite sheets.

The present inventors discovered that when generating carbon vapor (referred to below as the “plume”) in an atmosphere of inert gas to obtain a carbonaceous material, if a neon (Ne) gas atmosphere is used, then a new fine carbon particle that is different from dahlia-like fine carbon particles and bud-like fine carbon particles can be generated having a relatively narrow range for the particle-diameter distribution, and a carbonaceous material in which these fine carbon particles are aggregated can be readily obtained at a high yield.

In the manufacturing method of the present invention, unheated neon gas is preferably fed into the chamber in the ablation step; and a reaction temperature in the ablation step is preferably within a range of 2000° C. to 3000° C.

“Unheated neon gas” in this instance means neon gas that is fed into the chamber without any particular heating means having been provided within the supply pathway. The temperature of the neon gas is usually within an approximate range of 10 to 40° C., depending on the installation environment of the manufacturing apparatus.

In the process for generating these fine carbon particles, controlling the pressure, mass, specific heat, and thermal conductivity of the gas in the atmosphere, as well as controlling the temperature of the plume is important in order to ensure good reproducibility. The neon gas fed into the chamber is not heated, and the reaction temperature during the ablation step is within the aforementioned range, whereby a carbonaceous material in which a plurality of fine carbon particles is aggregated can be readily and reproducibly obtained.

In the method of the present invention, a pressure of the neon-gas atmosphere is preferably within a range of 93.1 kPa to 113.5 kPa.

The structure of the fine carbon particles is sensitive to the effects of the pressure of the neon-gas atmosphere, as described above. By ensuring that the pressure of the neon-gas atmosphere is in the aforementioned range, a carbonaceous material in which a plurality of fine carbon particles is aggregated can be obtained with better reproducibility.

In the method of the present invention, a graphite target is positioned within the chamber in the ablation step, and the graphite target is irradiated using a pulsed laser beam, whereby the plume can be efficiently generated.

The present invention may also include a purifying step performed after the cooling step. Specifically, in the purifying step, the carbonaceous material generated in the cooling step is heated to 400° C. to 500° C. in an oxidizing atmosphere, and the amount of components other than the fine carbon particles can be reduced.

The amount of impurities can be further reduced by performing this purifying step, and therefore the aforedescribed carbonaceous material in which fine carbon particles are aggregated can be obtained at higher purity.

The present invention may also include an oxidizing step performed after the cooling step. Specifically, in the oxidizing step, the fine carbon particles are exposed to an oxidizing atmosphere at 500° C. to 600° C., whereby the specific surface area of the fine carbon particles can be enlarged.

### EFFECT OF THE INVENTION

According to the manufacturing method of the present invention as described above, a carbonaceous material, in which fine carbon particles structured from clumps of numerous tube-shaped graphite sheets are aggregated, can be readily obtained at a high yield and having a fine carbon particle-diameter distribution that is in a relatively narrow range, and therefore a constant quality can be readily obtained for products in which such carbonaceous materials are used, and the manufacturing cost of such products can readily be reduced.

### BRIEF DESCRIPTION OF THE DRAWINGS

FIG. 1 is a partial cross-sectional view schematically showing an example of an apparatus used in the ablation and cooling steps of the present invention;

FIG. 2 shows photographic images obtained using transmission electron microscopy (TEM) on an example of the carbonaceous material that can be obtained using the manufacturing method of the present invention, wherein only the magnification was changed during photographing;

FIG. 3 shows oblique TEM photographic images of the carbonaceous material shown in FIG. 2, wherein only the tilt angle was changed during photographing;

FIG. 4 shows TEM photographic images of a dahlia-like carbon nanohorn aggregate, wherein only the magnification was changed;

FIG. 5 shows TEM photographic images of a bud-like carbon nanohorn aggregate, wherein only the magnification was changed;

FIG. 6(A) is a graph that shows an example of the results of Raman measurements performed on the carbonaceous material according to the present invention and on a dahlia-like carbon nanohorn aggregate (unpurified), respectively;

FIG. 6(B) is a graph that shows an example of the results of Raman measurements performed on the carbonaceous material according to the present invention and on a bud-like carbon nanohorn aggregate (unpurified), respectively;

FIG. 7(A) is a graph that shows an example of the relationship between heating temperature and percent change in weight when the carbonaceous material according to the present invention and a dahlia-like carbon nanohorn aggregate (unpurified) are each heated in air;

FIG. 7(B) is a graph that shows the derivative (differential curve) of the weight changes shown in FIG. 7(A);

FIG. 8(A) is a graph that shows an example of the relationship between heating temperature and percent change in weight when the carbonaceous material according to the present invention and a bud-like carbon nanohorn aggregate (unpurified) are each heated in air;

FIG. 8(B) is a graph that shows the derivative (differential curve) of the weight changes shown in FIG. 8(A);

FIG. 9 contains graphs that show examples of the results of Raman measurement, wherein FIG. 9(A) shows the states before and after the oxidizing of the carbonaceous material according to the present invention; FIG. 9(B) shows the states before and after the oxidizing of a dahlia-like carbon nanohorn aggregate (unpurified); and FIG. 9(C) shows the states before and after the oxidizing of a bud-like carbon nanohorn aggregate (unpurified); and

FIG. 10 is a graph that shows the results of measuring particle-diameter distributions for the fine carbon particles that constitute the carbonaceous material generated in the cooling step of Example 1 and for the dahlia-like fine carbon particles that constitute the dahlia-like carbon nanohorn aggregate generated and obtained in the cooling step of Comparative Example 1.

### KEY

3 Outer chamber
7 Inner chamber
10 Chamber
50 Ablation apparatus
CP Plume
PL Pulsed laser beam

### BEST MODE FOR CARRYING OUT THE INVENTION

A detailed description of a method for manufacturing a carbonaceous material according to an embodiment of the present invention is provided below. The method for manufacturing a carbonaceous material of the present embodiment includes an ablation step and a cooling step, and may include a purifying step or an oxidizing step when necessary. Each of the steps will be described in detail below with appropriate reference to the drawings.

[Ablation Step and Cooling Step]

A plume is generated in a neon-gas atmosphere within a chamber in the ablation step. The plume generated in the ablation step is cooled by the neon-gas atmosphere within the chamber in the cooling step. In the present invention, a carbonaceous material is obtained as a sooty material generated when the plume is cooled by the neon-gas atmosphere. Fine carbon particles structured from clumps of numerous tube-shaped graphite sheets are aggregated in this carbonaceous material. The method for generating the plume is not particularly limited, but may involve, e.g., laser ablation. The fine carbon particles according to the present invention are a new fine carbon particle that is different from dahlia-like fine carbon particles and bud-like fine carbon particles, as described above.

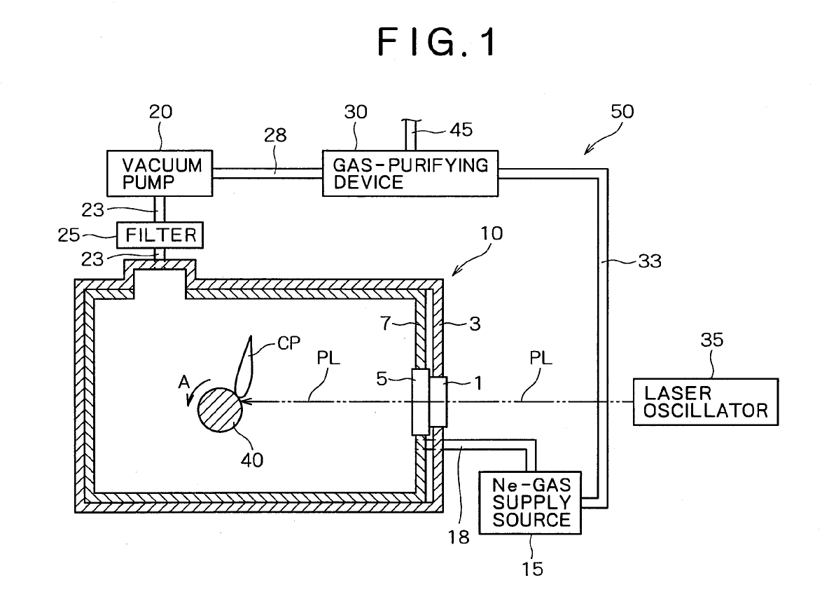

FIG. 1 is a partial cross-sectional view schematically showing an example of an apparatus (referred to below as an “ablation apparatus”) that can be used in the ablation and cooling steps. An ablation apparatus 50 shown in FIG. 1 is provided with a chamber 10 having a two-layered structure; an Ne-gas supply source 15 for feeding neon gas (abbreviated as “Ne gas” below) to the chamber 10; a vacuum pump 20 for evacuating the gas within the chamber 10; a filter 25 that is placed in front of the vacuum pump 20 to remove foreign solids in the gas evacuated by the vacuum pump 20; a gas-purifying device 30 for purifying the Ne gas in the gas evacuated by the vacuum pump 20 and for pumping the Ne gas to the Ne-gas supply source 15; and a laser oscillator 35 capable of oscillating a pulsed laser beam PL. The Ne gas in the evacuated gas is purified and reused in the present embodiment, but another aspect may also be used in which only new Ne gas is constantly fed into the chamber 10 without being reused.

The chamber 10 has a two-layered structure and is provided with an outer chamber 3 that has a focusing lens 1 for converging the pulsed laser beam PL that is emitted from the laser oscillator 35; and an inner chamber 7 that has a window 5 for transmitting the pulsed laser beam PL and for protecting the focusing lens 1 from the inside of the outer chamber 3. The outer chamber 3 is structured to be capable of being mounted on and removed from the inner chamber 7. A carbon target 40 is positioned within the chamber 10 during the manufacture of a carbonaceous material. Though omitted from FIG. 1, a support mechanism that supports the carbon target 40 and that is capable of causing the carbon target to rotate in the direction of the arrow A is present in the chamber 10. The pulsed laser beam PL is shown by a thick alternatingly double-dotted line in FIG. 1 for the sake of convenience.

The Ne-gas supply source 15 is connected to the chamber 10 by piping 18. The Ne gas is fed from the Ne-gas supply source 15, through the piping 18, and into the inner chamber 7. The vacuum pump 20 is connected to the chamber 10 by piping 23, and the filter 25 is positioned midway through the piping 23. The gas within the inner chamber 7 is suctioned out by the vacuum pump 20. The gas reaches the vacuum pump 20 after foreign solids have been removed by the filter 25 in a process involving passage through the piping 23, flows through piping 28, and enters the gas-purifying device 30. The gas-purifying device 30 purifies the Ne gas in the gas fed from the vacuum pump 20 and pumps the purified Ne gas through piping 33 to the Ne-gas supply source 15. Gas other than Ne gas is evacuated from the gas-purifying device 30 through piping 45 to the outside of the ablation apparatus 50.

The ablation step that is performed using the ablation apparatus 50 involves first positioning the carbon target 40 within the inner chamber 7, bringing the vacuum pump 20 into operation in this state, and evacuating the interior of the chamber 10 (inner chamber 7) to an initial vacuum of about 10⁻³ to 10⁻⁵ Pa. The gas (including water) that is evacuated at this point is pumped from the vacuum pump 20, through the piping 28, and into the gas-purifying device 30. [The gas] is then evacuated through the piping 45 without being purified by the gas-purifying device 30.

The Ne-gas supply source 15, the vacuum pump 20, and the gas-purifying device 30 are then brought into operation, and the inner chamber 7 is filled with an Ne-gas atmosphere of about 93.1 kPa to 113.5 kPa. Unheated Ne gas is fed into the inner chamber 7 from the Ne-gas supply source 15. Ne gas is preferably fed into the inner chamber 7 continuously during the manufacture of a carbonaceous material. From the standpoint of reproducibly generating the desired fine carbon particles, a pressure in the approximate range of 101.1 kPa to 110 kPa is particularly preferable for the atmosphere within the inner chamber 7 during manufacture.

The laser oscillator 35 is then brought into operation. The pulsed laser beam PL is oscillated and passed through the focusing lens 1 and the window 5 to irradiate the carbon target 40, and a plume CP is generated. The reaction temperature, i.e., the average temperature of the plume CP, during the ablation step is in the approximate range of 2000° C. to 3000° C., preferably in the approximate range of 2200° C. to 2900° C., and more preferably in the approximate range of 2300° C. to 2800° C., whereby fine carbon particles can be readily generated having a relatively high monodispersity, and the target carbonaceous material can be readily obtained at a high yield. The temperature of the plume CP can be adjusted by appropriately controlling, e.g., the flow volume of the Ne gas in the inner chamber 7, the irradiation energy per pulse of the pulsed laser beam PL, the pulse interval of the pulsed laser beam PL, the pulse frequency of the pulsed laser beam PL, and other factors.

For mass production of the target carbonaceous material, the carbon target 40 is preferably, e.g., a cylinder made of graphite. The carbon target 40 is preferably positioned so that the angle of incidence of the pulsed laser beam LP on the circumferential surface of the carbon target 40 is about 30° to 60°. Irradiation using the pulsed laser beam PL is preferably performed while causing the carbon target 40 to rotate around the long axis and while causing the carbon target and the location of incidence of the pulsed laser beam PL to move relative to one another so that the location of incidence moves back and forth in the direction of the long axis of the carbon target 40. The generation of amorphous carbon impurities can be readily controlled by making the angle of incidence of the pulsed laser beam PL on the carbon target 40 about 30° to 60°. The generation of amorphous carbon can be even more readily controlled by making the angle of incidence 40° to 50°. When the carbon target 40 shown in FIG. 1 is a cylinder, the direction of the long axis is parallel to the direction perpendicular to the page.

The temperature of the plume CP generated from the carbon target 40 is cooled by the Ne-gas atmosphere and naturally decreases away from the heat source, i.e., the pulsed laser beam PL, and a transition is automatically made to the cooling step. Once the plume CP is at or beyond a certain distance from the heat source, the target carbonaceous material will be generated as a sooty material.

The carbonaceous material (sooty material) is obtained adhering to the surfaces of the inner walls of the inner chamber 7 or in a suspended state within the inner chamber 7, and therefore the carbonaceous material is preferably recovered from the inner chamber 7 after letting the chamber 10 sit for a desired period of time after irradiation using the pulsed laser beam PL has been stopped.

The carbonaceous material can be recovered from the inner chamber 7 by, e.g., removing the inner chamber 7 from the chamber 10, injecting ethanol or another organic dispersion medium into [the inner chamber], and shaking to disperse the carbonaceous material within the inner chamber 7 into the organic dispersion medium. Depending on the type of organic dispersion medium, the resulting dispersion is then placed into a separate container, after which the organic dispersion medium is evaporated off, and the carbonaceous material is recovered. The carbonaceous material may also be recovered directly from within the inner chamber 7 by scraping or suctioning.

According to the manufacturing method of the present invention as described above, in which an ablation step and a cooling step are performed, a carbonaceous material can be readily obtained at a high yield (purity) of 95% or more having a fine carbon particle-diameter distribution that is in a relatively narrow range. New fine carbon particles, which are different from dahlia-like fine carbon particles and bud-like fine carbon particles, are aggregated in this carbonaceous material. Other than the fine carbon particles, the major component of the carbonaceous material is amorphous carbon.

The carbonaceous material according to the manufacturing method of the present invention has a large specific surface area having a value of about 400 to 420 m²/g by BET (Brunauer, Emmett, Teller) measurement. Considering that the specific surface areas of dahlia-like carbon nanohorn aggregates (unpurified) and bud-like carbon nanohorn aggregates (unpurified) have values of about 280 to 300 m²/g by BET measurement, the specific surface area of the carbonaceous material obtained by the manufacturing method of the present invention is extremely large. The bulk density of the carbonaceous material recovered from the chamber in a dry state is about 0.005 to 0.006 g/cm³. Considering that the bulk density of dahlia-like carbon nanohorn aggregates (unpurified) is about 0.01 g/cm³ when recovered from the chamber in a dry state, this bulk density has an extremely small value.

Such carbonaceous materials can be used as; e.g., (1) substrates (carriers) for carrying catalysts in oxidant electrodes or fuel electrodes in solid-polymer fuel cells, or other substrates (carriers) for carrying catalysts in various applications; (2) supports for biosensors; (3) adsorbents or structural materials for adsorbents for adsorbing the chemicals that cause sick building syndrome, nicotine, tar, DNA (ribonucleic acids), and the like; (4) sorbent materials for hydrogen gas or methane gas; (5) solid lubricants; (6) friction materials for increasing the frictional resistance of tires, bowling balls, and the like; and (7) pigments and the like. [These carbonaceous materials] can be used in a variety of applications as a substitute for conventional carbon black or activated carbon. According to the manufacturing method of the present invention, the range of the particle-diameter distribution of the fine carbon particles is relatively narrow, and a carbonaceous material can be readily obtained containing fine carbon particles at a high purity, and therefore products in which these carbonaceous materials are used can be readily made at a constant quality.

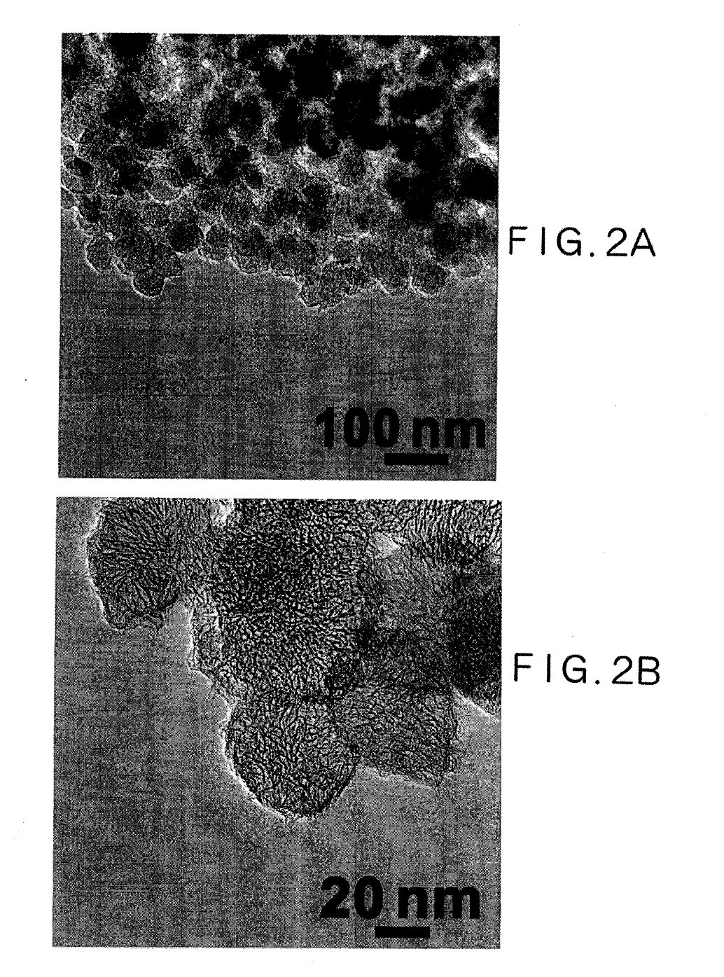

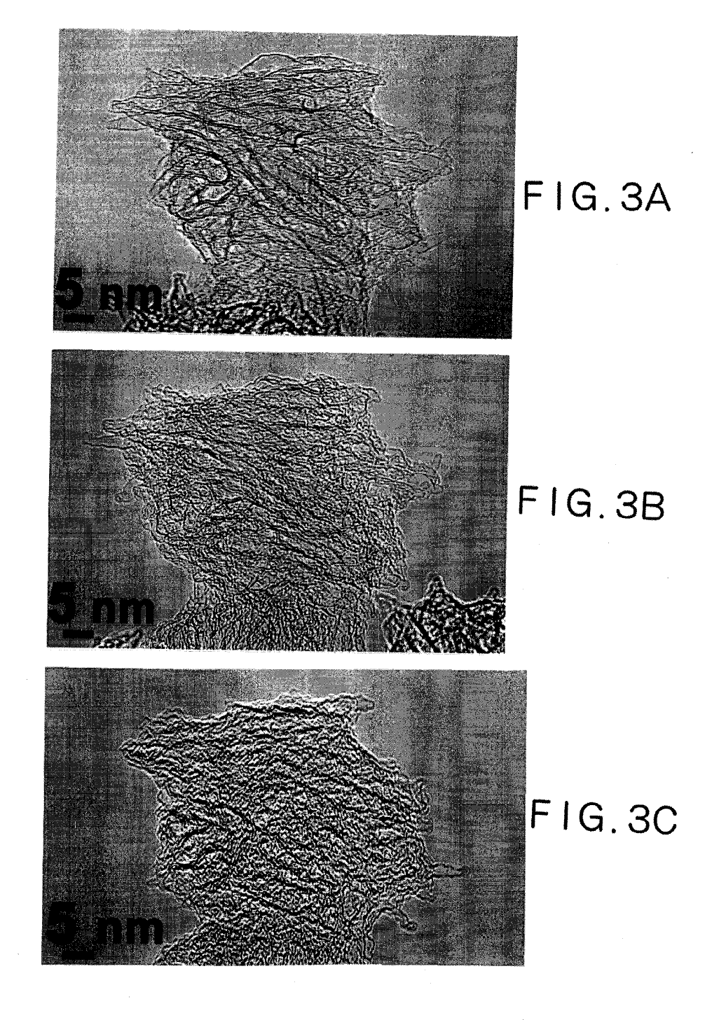

FIGS. 2(A) through 2(B) are photographic images obtained using transmission electron microscopy (TEM) on an example of the carbonaceous material that can be obtained using the manufacturing method of the present invention, wherein only the magnification was changed during photographing. The photographic magnification in FIG. 2(A) is 28000 times, and the photographic magnification in FIG. 2(B) is 110000 times. FIGS. 3(A) through 3(C) show oblique TEM photographic images of the fine carbon particles that constitute the aforementioned carbonaceous material, wherein only the tilt angle was changed during photographing. The magnification is 390,000. The tilt angle in FIG. 3(A) is 0 (zero) degrees, the tilt angle in FIG. 3(B) is −20°, and the tilt angle in FIG. 3(C) is +20°.

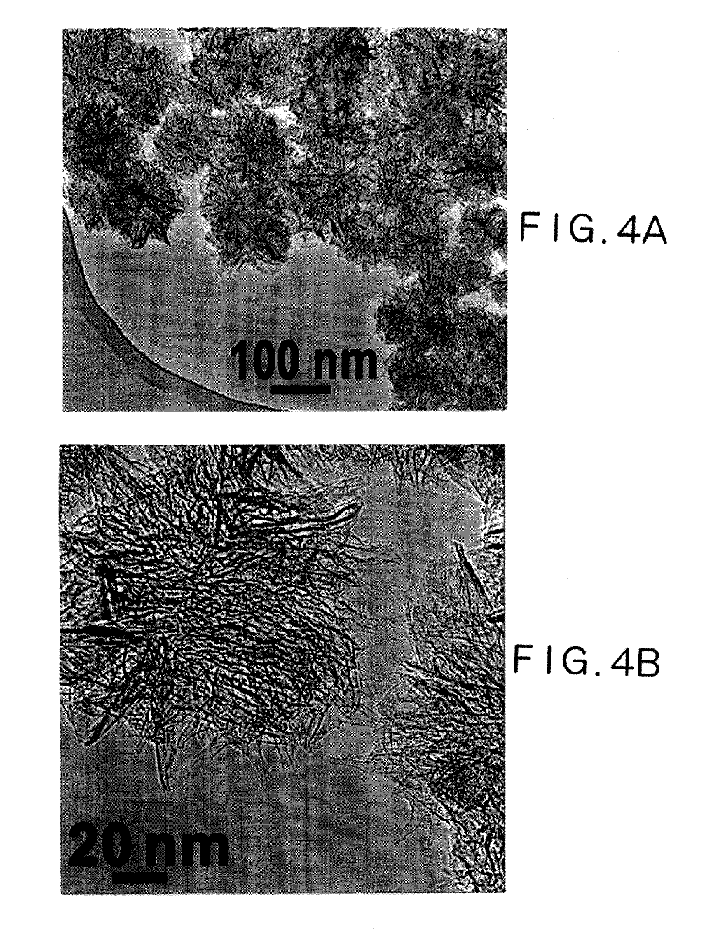

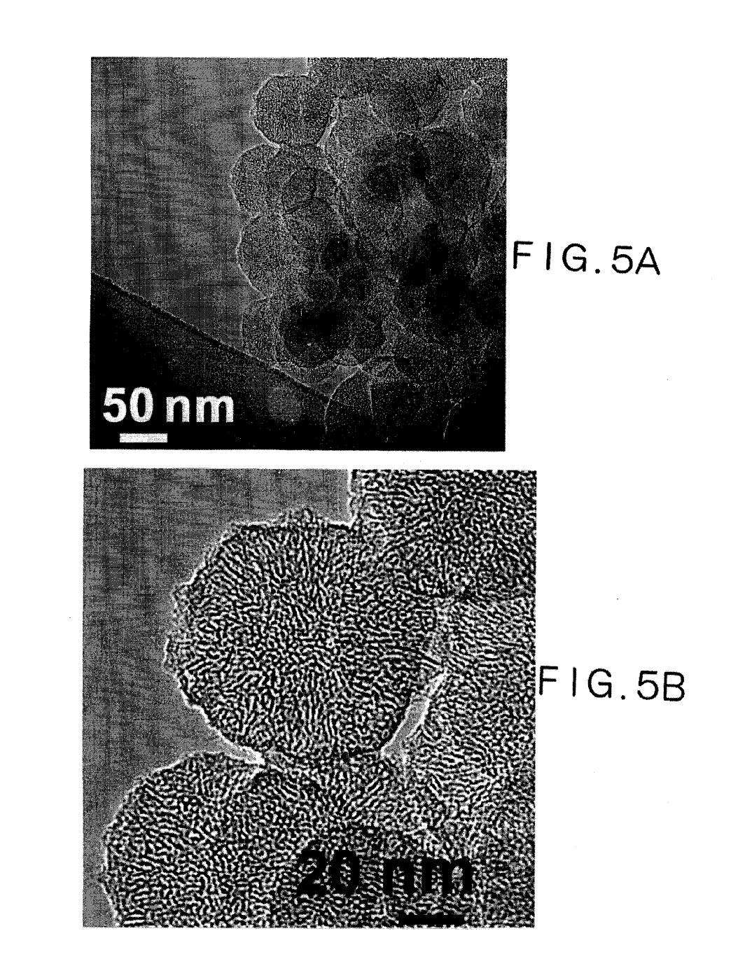

For reference, FIGS. 4(A) through 4(B) show TEM photographic images of a dahlia-like carbon nanohorn aggregate, wherein only the magnification was changed, and FIGS. 5(A) through 5(B) shows TEM photographic images of a bud-like carbon nanohorn aggregate, wherein only the magnification was changed. The photographic magnification in FIG. 4(A) is 28000 times, the photographic magnification in FIG. 4(B) is 110000 times, the photographic magnification in FIG. 5(A) is 55000 times, and the photographic magnification in FIG. 5(B) is 110000 times.

The carbonaceous material that can be obtained by the manufacturing method of the present invention is a material in which fine carbon particles are aggregated, as shown in FIGS. 2(A) through 2(B). The individual fine carbon particles are structured from clumps of tube-shaped graphite sheets, and horn-shaped protruding parts are substantially not present. The shape of the fine carbon particles according to the manufacturing method of the present invention resembles a more or less distorted “marimo (moss ball).” A small number of horn-shaped protrusions can be seen in the fine carbon particles in FIGS. 3(A) through 3(C), but the tips are rounded and do not taper to an acute angle. In contrast, the individual dahlia-like fine carbon particles that constitute a dahlia-like carbon nanohorn aggregate have numerous horn-shaped protrusions (carbon nanohorns) composed of tube-shaped graphite sheets, as shown in FIGS. 4(A) through 4(B). The tips of these protrusions all taper to an acute angle of about 20° C. when viewed from the surface. The fine carbon particles according to the manufacturing method of the present invention are therefore a material that is different from dahlia-like fine carbon particles. As a result, the carbonaceous material that can be obtained by the manufacturing method of the present invention is also recognized as a material that is different from dahlia-like carbon nanohorn aggregates.

Locations that appear to have a two-layered structure even when photographed from different tilt angles are found within the tube-shaped graphite sheets that constitute the fine carbon particles, as shown in FIGS. 3(A) through 3(C). Two-layered structures may be included in the tube-shaped graphite sheets that constitute the fine carbon particles. The new fine carbon particles obtained by oxidizing the fine carbon particles as described hereinafter have a larger specific surface area than the fine carbon particles before oxidation. Such an increase in specific surface area may be related to the two-layered structures that are included in the tube-shaped graphite sheets that constitute the fine carbon particles.

If only the shapes of the individual fine carbon particles are to be compared, the fine carbon particles according to the manufacturing method of the present invention resemble bud-like fine carbon particles. However, as is made clear from the contrast between FIGS. 2(A) through 2(B) and FIGS. 5(A) through 5(B), the fine carbon particles according to the manufacturing method of the present invention are generally smaller than bud-like fine carbon particles and have a maximum diameter of about 20 to 70 nm, whereas the maximum diameter of bud-like fine carbon particles is about 50 to 130 nm. Hollow structures resulting from tube-shaped graphite sheets can also be recognized when using TEM to observe bud-like fine carbon particles, but these hollow structures are in the central parts of the bud-like fine carbon particles, and the structures are non-uniform.

The fact that these fine carbon particles are a different material from dahlia-like fine carbon particles or bud-like fine carbon particles can also be confirmed using Raman spectroscopic measurement (Raman measurement).

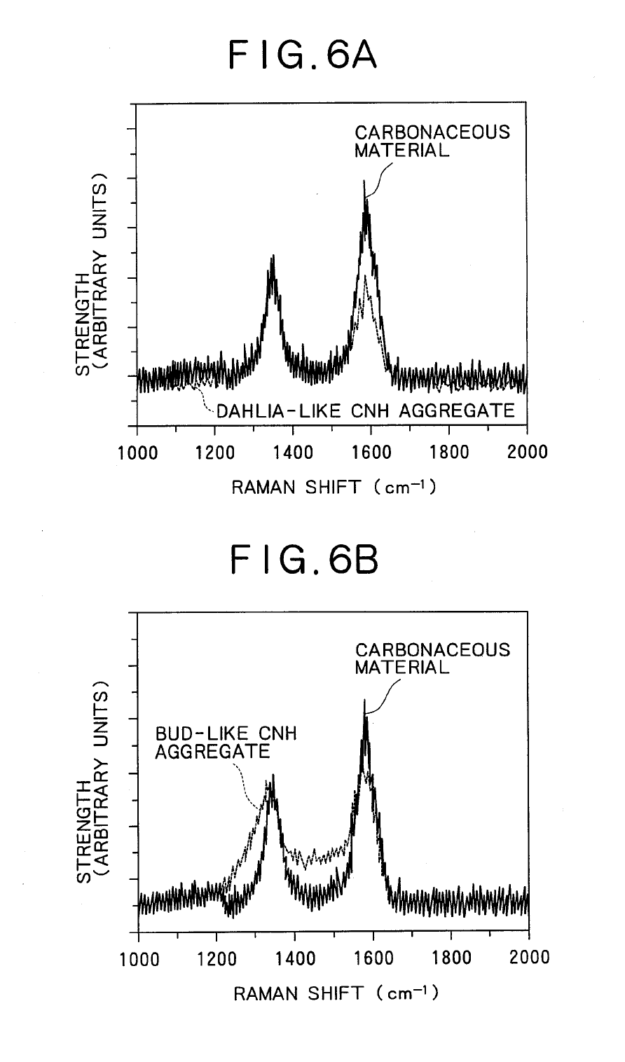

FIG. 6(A) is a graph that shows an example of the results of Raman measurements performed on the carbonaceous material according to the present invention and on a dahlia-like carbon nanohorn aggregate (unpurified), respectively. The measurement was performed at a measurement wavelength of 488 nm and an output of 50 mW using an NRS-2000 (model name) made by Jasco. The carbonaceous material according to the present invention is designated as “carbonaceous material” in FIG. 6(A) for the sake of convenience, and the measurement results for the dahlia-like carbon nanohorn aggregate are designated as “dahlia-like CNH aggregate.”

As is clear from the measurement results, large peaks appear near 1345 cm⁻¹ and 1590 cm⁻¹ when Raman measurement is performed on the carbonaceous material obtained by the manufacturing method of the present invention, as is the case for the dahlia-like carbon nanohorn aggregate. The large peak appearing near 1345 cm⁻¹ is referred to as the “D peak” and results from lattice defects in the carbon. Meanwhile, the large peak appearing near 1590 cm⁻¹ is referred to as the “G peak” and results from lattice vibrations within the surfaces of six-membered rings linked into a net shape (within the surfaces of the graphite sheets). Whereas the strength of the G peak is higher than the D peak in the carbonaceous material according to the present invention, the strength of the D peak is higher than the G peak in the dahlia-like carbon nanohorn aggregate.

This fact allows the determination that lattice defects in the graphite sheets are fewer in the fine carbon particles according to the manufacturing method of the present invention than in dahlia-like fine carbon particles. The fact that the fine carbon particles according to the manufacturing method of the present invention are a material that is different from dahlia-like fine carbon particles can therefore be recognized.

The results of Raman measurement performed on the carbonaceous material according to the present invention are also different from the results of Raman measurement performed on a bud-like carbon nanohorn aggregate (unpurified), as shown in FIG. 6(B). The carbonaceous material according to the present invention is designated as “carbonaceous material” in FIG. 6(B) for the sake of convenience, and the measurement results for the bud-like carbon nanohorn aggregate are designated as “bud-like CNH aggregate.”

In the bud-like carbon nanohorn aggregate, the D peak is broad, and the strength between the D peak and the G peak is large in comparison with the carbonaceous material. This fact demonstrates that the bud-like carbon nanohorn aggregate contains a large amount of amorphous carbon. The carbonaceous material according to the present invention can therefore be recognized as a material that is different from bud-like carbon nanohorn aggregates.

Meanwhile, the fact that the fine carbon particles in the carbonaceous material according to the present invention are highly pure can be readily understood from the relationship between heating temperature and weight change when the resulting carbonaceous material is heated in an oxidizing atmosphere; i.e., from the results of thermogravimetric measurement.

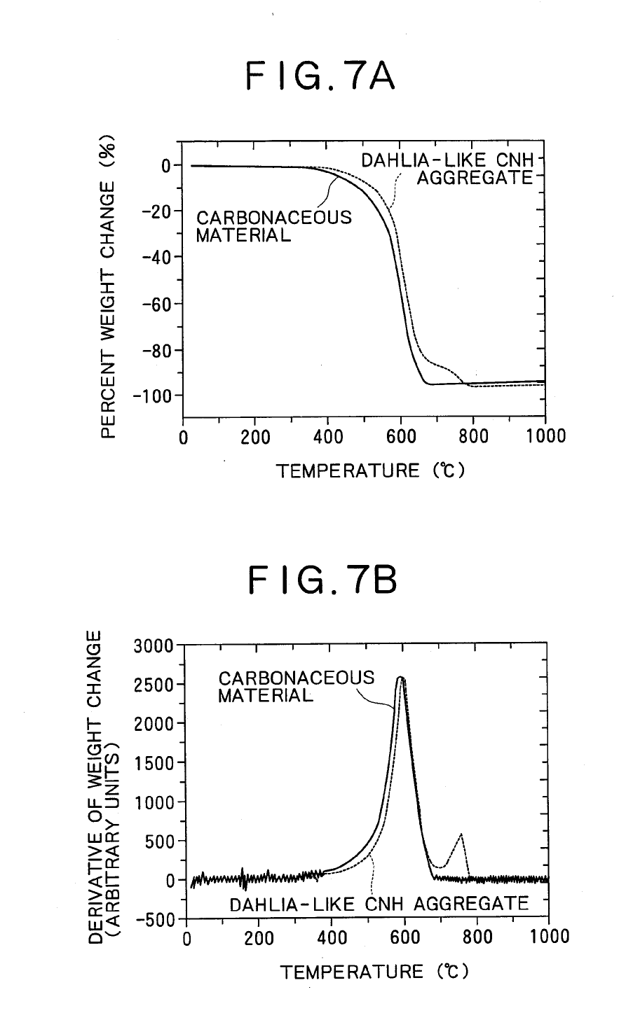

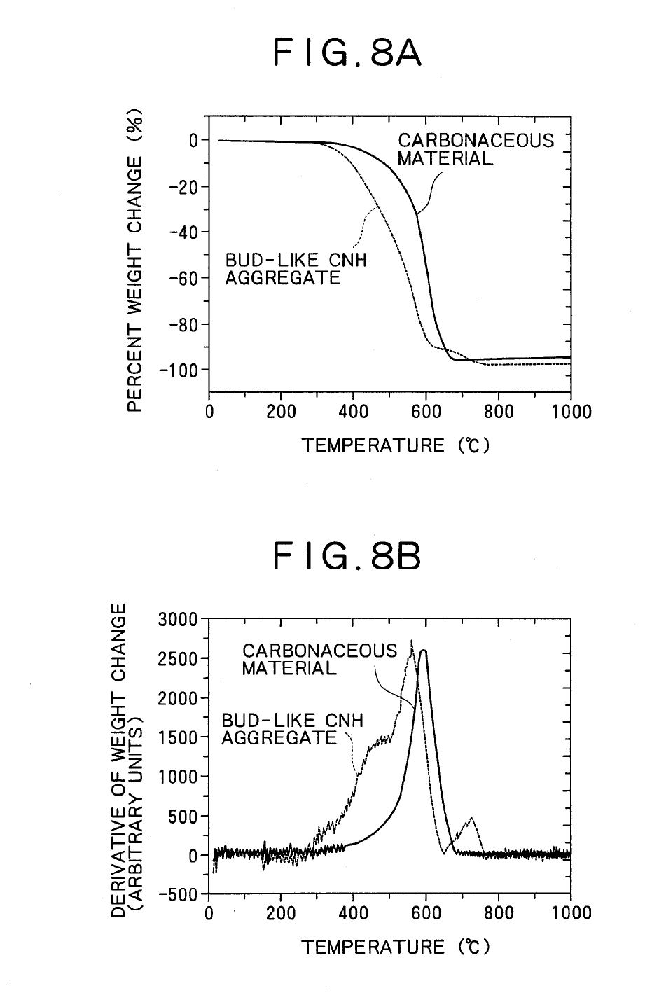

FIG. 7(A) is a graph that shows an example of the relationship between heating temperature and percent change in weight when the carbonaceous material according to the present invention (“carbonaceous material” in FIG. 7(A)) and a dahlia-like carbon nanohorn aggregate (“dahlia-like CNH material” in FIG. 7(A), unpurified) are each heated in air. FIG. 7(B) is a graph that shows the derivative (differential curve) of the weight changes shown in FIG. 7(A). FIG. 8(A) is a graph that shows an example of the relationship between heating temperature and percent change in weight when the carbonaceous material according to the present invention (“carbonaceous material” in FIG. 8(A)) and a bud-like carbon nanohorn aggregate (“bud-like CNH material” in FIG. 8(A), unpurified) are each heated in air. FIG. 8(B) is a graph that shows the derivative (differential curve) of the weight changes shown in FIG. 8(A).

When the carbonaceous material according the present invention is heated in air, the weight decreases slowly when the heating temperature is about 400° C. to 500° C. and is substantially constant after rapidly decreasing from 500° C. until near 700° C., as shown in FIGS. 7(A) and 7(B). The decrease in weight from 400° C. to 500° C. is thought to be due to the combustion of amorphous carbon impurities, and the rapid decrease in weight from 500° C. to 700° C. is thought to be due to the combustion of fine carbon particles. Meanwhile, when a dahlia-like carbon nanohorn aggregate (unpurified) is heated in air, the weight decreases from near 400° C. to near 700° C. in the same fashion as the carbonaceous material according to the present invention, but the weight decreases slowly from near 700° C. to near 750° C., as shown in FIGS. 7(A) and 7(B). The change in weight from near 700° C. to near 750° C. is thought to result from the combustion of clumped graphite impurities. It is accordingly determined that the purity of the fine carbon particles in the carbonaceous material according to the present invention is higher than the purity of the dahlia-like fine carbon particles in the dahlia-like carbon nanohorn aggregate (unpurified).

When a bud-like carbon nanohorn aggregate (unpurified) is heated in air, the weight decreases rapidly from near 300° C. to 500° C. and then decreases rapidly once again from near 500° C. to near 600° C., as shown in FIGS. 8(A) and 8(B). The weight also decreases slowly at near 700° C. The rapid decrease in weight from near 300° C. to near 500° C. is thought to be the combustion of amorphous carbon impurities, and the rapid decrease in weight from near 500° C. to near 600° C. is thought to be the combustion bud-like fine carbon particles. The slow decrease in weight near 700° C. is thought to result from the combustion of clumped graphite impurities. It is accordingly determined that the purity of the fine carbon particles in the carbonaceous material according to the present invention is higher than the purity of the bud-like fine carbon particles in the bud-like carbon nanohorn aggregate (unpurified).

[Purifying Step]

A purifying step may be included as necessary in the method for manufacturing a carbonaceous material of the present invention. This purifying step involves reducing the weight of components other than fine carbon particles in the carbonaceous material generated in the cooling step. In the purifying step, the carbonaceous material generated in the cooling step is heated to 400° C. to 500° C. in an oxidizing atmosphere. The oxidizing atmosphere should be capable of burning the amorphous carbon impurities included in the carbonaceous material, but air is preferably used in consideration of cost. The treatment time for the purifying step may be appropriately selected according to the heating temperature from within an approximate range of 5 to 30 minutes. A carbonaceous material having fine carbon particles of about 99% purity can be obtained by performing this purifying step. Performing the purifying step in air for about 10 minutes at 450° C. is preferable from the standpoint of efficiently removing the amorphous carbon.

[Oxidizing Step]

An oxidizing step may be included as necessary in the method for manufacturing a carbonaceous material of the present invention. In this oxidizing step, the fine carbon particles are exposed to an oxidizing atmosphere at 500° C. to 600° C., whereby fine carbon particles are obtained having a specific surface area that is larger than in the fine carbon particles generated in the cooling step. The oxidizing atmosphere is not particularly limited, but air preferably used in consideration of cost and other concerns. The treatment time for the oxidizing step may be appropriately selected according to the temperature of the oxidizing atmosphere from within an approximate range of 5 to 30 minutes. The aforedescribed purifying step may be combined with the oxidizing step. Performing the oxidizing step together with the purifying step in air for about 10 minutes at 550° C. is preferable from the standpoint of efficiency.

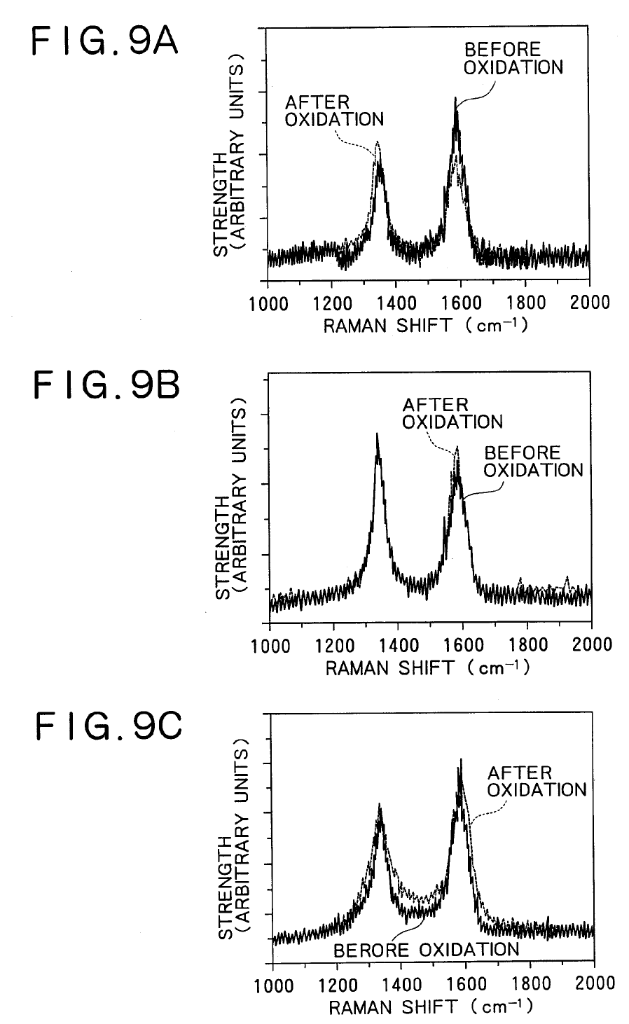

The reason that the specific surface area of the fine carbon particles can be enlarged by performing the oxidizing step is not certain, but from speculating on the results of Raman measurement, [this enlargement] is thought to be due to the generation of lattice defects in the tube-shaped graphite sheets that constitute the fine carbon particles and to the formation of apertures in these tube-shaped compounds. FIG. 9(A) is a graph that shows an example of the results of Raman measurements on the carbonaceous material according to the present invention (before oxidation) and on a compound resulting from performing an oxidizing step in which this carbonaceous material was exposed to air for 10 minutes at 550° C. (after oxidation), respectively. The D peak is higher and the G peak is lower after oxidation than before, as shown in FIG. 9(A). This fact demonstrates that lattice defects in the fine carbon particles have increased due to performing the oxidizing step.

Meanwhile, when an oxidizing step is performed in which a dahlia-like carbon nanohorn aggregate (unpurified) is exposed to air for 10 minutes at 550° C., the G peak increases and the D peak does not substantially change in comparison to the case in which oxidation is not performed, as shown in FIG. 9(B). This change is speculated to result from the high proportion of clumped graphite impurities. When an oxidizing step is performed in which a bud-like carbon nanohorn aggregate (unpurified) is exposed to air for 10 minutes at 550° C., the G peak and the D peak both increase by substantially the same amount in comparison to the case in which oxidation is not performed, as shown in FIG. 9(C). This change is speculated to result from the poor crystallization of bud-like carbon nanohorn aggregates (the poor crystallization of bud-like fine carbon particles).

As described above, the specific surface area of the fine carbon particles can be enlarged by performing the oxidizing step on the carbonaceous material that can be obtained by the manufacturing method of the present invention, and therefore a carbonaceous material having a further enlarged specific surface area can be obtained from the carbonaceous material generated in the cooling step or from a carbonaceous material that has passed through to the purifying step. The value of the specific surface area of the carbonaceous material after oxidation is, e.g., 1500 to 1700 m²/g by BET measurement. This value for the specific surface area is extremely large considering that the specific surface areas (the values resulting from BET measurement) of carbonaceous materials obtained by oxidizing dahlia-like carbon nanohorn aggregates or bud-like carbon nanohorn aggregates are all about 1000 to 1250 m²/g.

Like the pre-oxidation carbonaceous material, carbonaceous materials having such a large specific surface area can be used as substrates for carrying catalysts, supports for biosensors, adsorbents or materials for adsorbents, sorbent materials for hydrogen gas or methane gas, solid lubricants, friction materials, pigments, and the like, and are particularly ideal as substrates for carrying catalysts, adsorbents or materials for adsorbents, sorbent materials for hydrogen gas or methane gas, and the like. When performing the oxidizing step and the purifying step separately, the oxidizing step is performed after the purifying step.

### EXAMPLES

### Example 1

### Ablation Step and Cooling Step

The ablation apparatus 50 shown in FIG. 1 and a carbon target composed of a graphite cylinder were used. The capacity of the inner chamber constituting the ablation apparatus was 30 cm³, and the carbon target was a cylinder having a diameter of 30 mm and a length of 50 mm.

The carbon target was positioned within the inner chamber, and an initial vacuum of 10⁻³ Pa was created in the inner chamber. 99.99%-pure Ne gas was then fed continuously into the inner chamber at a flow volume of 30 cm³/min. The Ne gas was continuously evacuated by a vacuum pump, and the pressure of the Ne-gas atmosphere within the inner chamber was stabilized at 101.3 kPa. A pulsed laser beam (carbon dioxide gas laser beam) having an irradiation energy of 20 kW/cm² per pulse was used to irradiate the carbon target in this state for 1 minute at an angle of incidence of 45°, a pulse width of 1000 ms, a pulse interval of 250 ms, and a pulse frequency of 0.8 Hz, while the carbon target was rotated at a speed of 6 rpm. A plume was generated from the carbon target due to the irradiation of the pulsed laser beam. The plume was cooled by the Ne-gas atmosphere, and a carbonaceous material in which fine carbon particles were aggregated was obtained. This carbonaceous material was obtained as a sooty material adhering to the surface of the inner walls of the inner chamber or in a suspended state within the inner chamber.

The suspended carbonaceous material was removed from the inner chamber after waiting for the material to deposit onto the bottom of the inner chamber. Ethanol was injected, [the chamber] was shaken, and the carbonaceous material within the inner chamber was dispersed into the ethanol. The ethanol into which the carbonaceous material had been dispersed was moved to a separate container, and the ethanol was evaporated off. 0.5 g of a 95%-pure carbonaceous material in which fine carbon particles were aggregated was thereby obtained.

Images similar to those shown FIGS. 2(A), 2(B), or 3(A) through 3(C) were observed when this carbonaceous material was observed using TEM (transmission electron microscopy) and oblique TEM. Measurement results similar to the results shown in FIG. 6(A) were obtained when Raman measurement was performed. Measurement results similar to the results shown in FIG. 7(A) were obtained when the relationship between heating temperature and percent change in weight when the carbonaceous material was heated in air was determined.

(Oxidizing Step)

The aforementioned carbonaceous material was heated in air for 10 minutes at 550° C., whereby readily combustible amorphous carbon was burned away, and the carbonaceous material was purified and oxidized, enlarging the specific surface area. The purity of the carbonaceous material was thereby improved to 99%. Measurement results similar to the results shown in FIG. 9(A) were obtained when Raman measurement was performed on this oxidized carbonaceous material.

### Example 2

After performing the ablation step and the cooling step under the same conditions as in Example 1, the sooty material was scraped out directly from within the inner chamber, and a carbonaceous material was obtained.

### Comparative Example 1

### Ablation Step and Cooling Step

The ablation and cooling steps were performed under the same conditions as Example 1, except that the atmosphere within the inner chamber was 98-kPa argon (Ar) gas, and the pulsed laser beam (carbon dioxide gas laser beam) had a pulse width of 500 ms, a pulse interval of 500 ms, and a pulse frequency of 1 Hz. A dahlia-like carbon nanohorn aggregate in which dahlia-like fine carbon particles were aggregated was obtained. This dahlia-like carbon nanohorn aggregate was obtained as a sooty material adhering to the inner walls of the inner chamber or in a suspended state within the inner chamber. The dahlia-like carbon nanohorn aggregate within the inner chamber was then recovered using the same method as in Example 2, and 0.3 g of an 85%-pure dahlia-like carbon nanohorn aggregate was obtained.

Images similar to those shown FIGS. 4(A) and 4(B) were observed when the resulting dahlia-like carbon nanohorn aggregate was observed using TEM. Measurement results similar to the results shown in FIG. 6(A) were obtained when Raman measurement was performed. Measurement results similar to the results shown in FIG. 7(A) were obtained when the relationship between heating temperature and percent change in weight when the dahlia-like carbon nanohorn aggregate was heated in air was determined.

(Oxidizing Step)

The aforementioned dahlia-like carbon nanohorn aggregate was heated in air for 10 minutes at 550° C., whereby the dahlia-like carbon nanohorn aggregate was purified, the dahlia-like fine carbon particles constituting the dahlia-like carbon nanohorn aggregate were oxidized, and 0.27 g of a 90%-pure dahlia-like carbon nanohorn aggregate was obtained. Measurement results similar to the results shown in FIG. 9(B) were obtained when Raman measurement was performed on this dahlia-like carbon nanohorn aggregate.

### Comparative Example 2

### Ablation Step and Cooling Step

The ablation and cooling steps were performed under the same conditions as Example 1, except that the atmosphere within the inner chamber was 98-kPa helium (He) gas, and the pulsed laser beam (carbon dioxide gas laser beam) had a pulse width of 500 ms, a pulse interval of 500 ms, and a pulse frequency of 1 Hz. A bud-like carbon nanohorn aggregate in which bud-like fine carbon particles were aggregated was obtained. This bud-like carbon nanohorn aggregate was obtained as a sooty material adhering to the inner walls of the inner chamber or in a suspended state within the inner chamber. The bud-like carbon nanohorn aggregate within the inner chamber was then recovered using the same method as in Example 1, and 0.1 g of a 70%-pure bud-like carbon nanohorn aggregate was obtained.

Images similar to those shown FIGS. 5(A) and 5(B) were observed when the resulting bud-like carbon nanohorn aggregate was observed using TEM. Measurement results similar to the results shown in FIG. 6(B) were obtained when Raman measurement was performed. Measurement results similar to the results shown in FIG. 7(B) were obtained when the relationship between heating temperature and percent change in weight when the bud-like carbon nanohorn aggregate was heated in air was determined.

(Oxidizing Step)

The aforementioned bud-like carbon nanohorn aggregate was heated in air for 10 minutes at 550° C., whereby the bud-like carbon nanohorn aggregate was purified, the bud-like fine carbon particles constituting the bud-like carbon nanohorn aggregate were oxidized, and 0.07 g of an 80%-pure bud-like carbon nanohorn aggregate was obtained. Measurement results similar to the results shown in FIG. 9(C) were obtained when Raman measurement was performed on this bud-like carbon nanohorn aggregate.

[Evaluation 1: Particle Diameter Distribution]

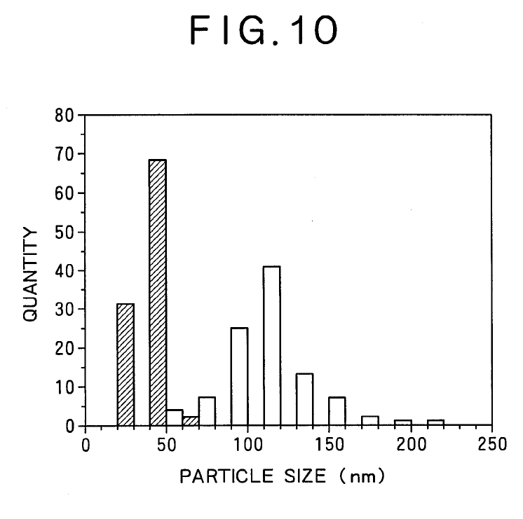

TEM was used to observe the carbonaceous material generated in the cooling step of Example 1 and the dahlia-like carbon nanohorn aggregate generated in the cooling step of Comparative Example 1. The respective sizes of the fine carbon particles constituting the carbonaceous material of Example 1 and the dahlia-like fine carbon particles constituting the dahlia-like carbon nanohorn aggregate were measured one by one on the basis of the TEM photographs, and particle-diameter distributions were determined for these fine carbon particles. The results are shown in FIG. 10. The measurement results for the carbonaceous material generated in the cooling step of Example 1 are shown by the hatched histogram in FIG. 10, and the measurement results for the dahlia-like carbon nanohorn aggregate generated in the cooling step of Comparative Example 1 are shown by the white outlined histogram.

As is made clear from FIG. 10, the particle-diameter distribution of the fine carbon particles of Example 1 is in the relatively narrow range of 20 to 70 nm. In contrast, the particle-diameter distribution of the dahlia-like fine carbon particles spans a wide range of 50 to 220 nm. Whereas the average value for the size of the fine carbon particles of Example 1 is small at 43.8 nm, the average value for the size of the dahlia-like fine carbon particles is 107.8 nm, which is two or more times the average value for the size of the fine carbon particles.

[Evaluation 2: Specific Surface Area]

BET measurement was used to determine the respective specific surface areas of the carbonaceous material generated in the cooling step of Example 1 (the pre-oxidation oxygen), the oxidized carbonaceous material obtained in Example 1, the dahlia-like carbon nanohorn aggregate generated in the cooling step of Comparative Example 1, the dahlia-like carbon nanohorn aggregate obtained in the oxidizing step of Comparative Example 1, the bud-like carbon nanohorn aggregate generated in the cooling step of Comparative Example 2, and the bud-like dahlia-like carbon nanohorn aggregate obtained in the oxidizing step of Comparative Example 2. The aforementioned specific surface areas were obtained by measuring the absorption amount of nitrogen gas using an ASAP-200 (model name) made by Shimadzu Co. The results are shown in Table 1. “CNH” in Table 1 refers to “carbon nanohorn aggregate.”

TABLE 1

| | Specific |
|---|---|
| Carbonaceous material | Surface Area |
| Carbonaceous material generated in cooling | 425 m²/g |
| step of Example 1 | |
| Carbonaceous material obtained in oxidizing | 1703 m²/g |
| step of Example 1 | |
| Dahlia-like CNH aggregate generated in | 300 m²/g |
| cooling step of Comparative Example 1 | |
| Dahlia-like CNH aggregate obtained in | 1247 m²/g |
| oxidizing step of Comparative Example 1 | |
| Bud-like CNH aggregate generated in cooling | 280 m²/g |
| step of Comparative Example 2 | |
| Bud-like CNH aggregate obtained in | 1258 m²/g |
| oxidizing step of Comparative Example 2 | |

As is made clear from Table 1, the pre-oxidation carbonaceous material obtained by the manufacturing method of the present invention has an extremely large specific surface area even in comparison to both un-oxidized dahlia-like carbon nanohorn aggregates and un-oxidized bud-like carbon nanohorn aggregates. The oxidized carbonaceous material obtained by the manufacturing method of the present invention also has an extremely large specific surface area even in comparison to both oxidized dahlia-like carbon nanohorn aggregates and oxidized bud-like carbon nanohorn aggregates.

[Evaluation 3: Bulk Density]

Bulk density was determined for both the pre-oxidation carbonaceous material obtained in Example 2 and the dahlia-like carbon nanohorn aggregate generated in the cooling step of Comparative Example 1. The results were that the bulk density of the carbonaceous material obtained in Example 2 had a small value of 0.006 g/cm³, whereas the bulk density of the dahlia-like carbon nanohorn aggregate generated in the cooling step of Comparative Example 1 had a large value 0.015 g/cm³.

### INDUSTRIAL APPLICABILITY

The carbonaceous material of the present invention is useful as a substrate (carrier) for carrying catalysts, an adsorbent or the structural material of an adsorbent for adsorbing DNA (deoxyribonucleic acid) or the like, a sorbent material for hydrogen gas or methane gas, a solid lubricant, a friction material, or in other applications.

1. A method for manufacturing a carbonaceous material, characterized in comprising:
a carbon ablation step performed in a neon-gas atmosphere within a chamber; and
a cooling step for using said neon-gas atmosphere within said chamber to cool a gasified carbon generated in the ablation step, wherein
a carbonaceous material in which a plurality of fine carbon particles is aggregated is thereby obtained.

2. The method for manufacturing a carbonaceous material according to claim 1, characterized in that said fine carbon particles are structured from clumps of numerous tube-shaped graphite sheets.

3. The method for manufacturing a carbonaceous material according to claim 1, characterized in that
unheated neon gas is fed into said chamber in said ablation step; and
a reaction temperature in said ablation step is within a range of 2000° C. to 3000° C.

4. The method for manufacturing a carbonaceous material according to claim 3, characterized in that a pressure of said neon-gas atmosphere is within a range of 93.1 kPa to 113.5 kPa.

5. The method for manufacturing a carbonaceous material according to claim 1, characterized in:
positioning a graphite target within said chamber in said ablation step;
irradiating said graphite target using a pulsed laser beam; and
generating said gasified carbon.

6. The method for manufacturing a carbonaceous material according to claim 1, characterized in further comprising a purifying step for heating the carbonaceous material generated in said cooling step to 400° C. to 500° C. in an oxidizing atmosphere and reducing an amount of components other than said fine carbon particles.

7. The method for manufacturing a carbonaceous material according to claim 1, characterized in exposing the fine carbon particles obtained after said cooling step to an oxidizing atmosphere at 500° C. to 600° C. and thereby enlarging a specific surface area of said fine carbon particles.
